(19) United States
(12) Patent Application Publication
(10) Pub. No.: US 2014/0186804 A1
(43) Pub. Date: Jul. 3, 2014

(54) Color Wheel Artistic Implement

(71) Applicant: Mr. Bihua Liu, (US)

(72) Inventor: Bihua Liu, Bayside, NY (US)

(73) Assignee: Mr. Bihua Liu, Bayside, NY (US)

(21) Appl. No.: 13/730,762

(22) Filed: Dec. 28, 2012

(51) Int. Cl. G09B 19/00

(52) U.S. Cl. CPC G09B 19/0023
USPC 434/81

(57) ABSTRACT

This invention is intended to spark an art renaissance in our youth by getting back to basic color blending. In the age of computer-generated graphics and 64-box crayons, our youth have lost the ability to create their own shades and hues in a meaningful way that imparts their emotion, psyche, and intent into an artistic medium. Self-expression and individuality are the cornerstones of this great democracy, so empowering our youth to create a full spectrum of colors from the basic color wheel fosters the pioneer spirit upon which America is built. Every single color imaginable can be created from a color wheel consisting of the three primary colors plus black and white. The Color Wheel Artistic Implement is novel because it places the world of colors in the hands of children cheaply, with minimal processing, and with no waste. There are ten claims submitted with five drawings.

### BACKGROUND OF THE INVENTION

1. Field of the Invention

This invention relates to artistic implements that apply color to an artistic medium. This implement is novel because the consumer not only learns how to create all colors possible from the three primary colors plus black and white, but also learns how to create three styles of traditional Chinese art through a book and DVD that teach nonobvious techniques.

2. Description of the Prior Art

(1) U.S. Pat. No. 2,130,011 to Hersinhod: Ilie Hersinhod's multicolor pencil was revolutionary in its time because it cut down on waste and solved the problem of complicated mechanisms that soon wore out. The problem with its use today is that it involves a complicated manufacturing process of creating color within color within color, much like a Russian nesting doll. Plus, only one color could be used at a time so it is more suited as a writing implement rather than an artistic implement.

Mr. Lui's invention cuts out waste even more by not using wood and instead using the compressed toner powders to form the body of the implement. A thin layer of wax covers the implement and keeps the colors from bleeding. The wax is removed by sharpening in a regular pencil sharpener or by slightly rubbing the portion desired to be used on a small piece of sandpaper. The consumer can choose which and how many colors to use at any given moment. While Hersinhod's pencil was limited to monochromatic drawing, Liu's implement can draw polychromatically, can blend colors and hues, and can mimic three traditional styles of Chinese art with nonobvious techniques.

(2) U.S. Pat. No. 2,883,966 to Germann: Werner Germann's pencil is a good example of the type of complicated, wasteful contraption that Hersinhod's pencil sought to replace over two decades prior. Germann's pencil rotated multiple leads of different colors to enter a central chute one by one. Although many more colored leads could be accommodated than ever before, this pencil was still limited to monochromatic drawings with little practicability for art.

Mr. Liu's implement is an improvement over Germann's multiple lead capabilities, because it capitalizes on the notion that every color under the sun can be made from the three primary colors plus black and white. Advanced artists can use the implement that contains the three secondary colors plus black and white, and masters can create special ordered implements to match their color needs. But every single child in all the schools in the world can have the color wheel in their hands in one simple device that costs less than fifty cents each to produce.

(3) U.S. Pat. No. 6,081,689 to Houston: Robert D. Houston's artists' chalk utilizes used printer toner cooked at high temperatures to turn it into a chalk substance suitable for charcoal type portraits. While his recycling efforts are commendable, there is a huge problem. Printer toner is highly toxic and cannot be placed into the hands of children. Moreover, Houston's chalk is monochromatic.

Interestingly, Houston's patent teaches that Leonardo Semenoff has made, on a non-commercial basis, sticks of used toner that was compressed and not baked. These are also monochromatic, limited for use in lithography only, and have the problem of being very crumbly.

Liu's implement overcomes all the problems of the baked and compressed toners. Liu uses compressed pastel powders which are more cohesive, nontoxic, and non-crumbly. These compressed pastel powders can easily be compressed onto other compressed pastel powders. A thin layer of wax around the cylinder body prevents the colors from bleeding onto the hands of the consumer. The colors remain intact until imparted onto an art medium. The consistency of the compressed pastel powder allows for a wide-range of applicability.

(4) U.S. Pat. No. 0,003,061 to Andreas: Thies Andreas' pencil utilizes a single color enclosed by a wood-replacement material. The new material, which was patented by J. S. Staedtler and Andres with others (Int'l Publication No. 2010/006743A1 to Staedtler) provided for greater bending strength.

Liu's implement is similarly more pliable than a wood-encased implement without the waste of Andreas' wood alternative. Moreover, Liu's implement can accommodate up to four colors where Andreas' pencil is monochromatic.

(5) U.S. Pat. No. 7,950,862 to Shim: Youngtack Shim's multi-color writing tool is another good example of the type of complicated, wasteful contraption that Hersinhod's pencil sought to replace over six decades prior. Although Shim's tool utilized multiple colors, they could not be blended and can only be used one at a time.

Liu's implement is an improvement because it allows for blending and multi-color usage. Moreover, there is no waste and no complicated contraption that drives up production costs.

(6) Chinese Publication No. 2138571 to Zhou: Yiren Zhou's multicolor pencil recognized the need for calligraphers to use different colors for special occasions. However, Zhou's invention was a complicated contraption that could only utilize one color at a time.

Liu's implement cuts down production costs because of its simplicity, and allows the user to custom blend the colors of choice.

(7) Chinese Publication No. 2510300 Y to Daxiong: Zhao Daxiong's combined multicolor pencil vertically separated two, four or six colors that were encased in a regular style pencil lead. This dispensed with the need for expensive and wasteful mechanical contraptions, but its use is limited to writing and drawing.

Liu's invention does not encase the colors with regular pencil lead, and through non-obvious techniques the user can be taught to custom blend any color imaginable and also to mimic three traditional styles of Chinese art, as more fully explained infra. It should be noted that Liu's invention does not claim beyond four colors because any number beyond that becomes very expensive to produce.

(8) Chinese Publication No. 101870219 A to Wang: Xinran Wang's magic color painting pencil was revolutionary because it blended color particles to be used in one lead core so that students would be more interested in writing. It improved upon Daxiong's idea by dispensing with the cumbersome lead surrounding the colors so that the student could write in true rainbow style. The problem with this invention is that the colors flowing from the implement are random and the user has no control over it. Plus the pencil was limited to drawing, writing and sketching because only the point can be used due to the encasing of non-usable materials.

Liu's implement solves this problem by using only a thin wax covering over two, three, or four clearly delineated colors that can be used monochromatically or controlled blending. Liu's implement can be used not only for drawing, writing and sketching, but it also can be used through nonobvious techniques to mimic three styles of Chinese traditional art, as described infra.

(9) Chinese Publication No. 0125765 X to Liu: Bihua Liu, the present inventor, has also patented a precursor to this invention in China. That invention involved a multicolor pencil with two, three and four vertical leads.

This invention improves upon the idea of vertical colors by compressing toners of a pastel-like consistency for easy blending, and covering the colors with a thin layer of wax so that nonobvious techniques can be employed to mimic three traditional Chinese styles of art, as described infra.

### SUMMARY OF THE INVENTION

This invention seeks to empower children to master the color wheel by creating their own colors, shades, and hues. This in turn should spark an art renaissance bolstering the American ideals of creativity, individuality and self-expression. Every child is a budding artist and this invention puts the color wheel in each child's hand cheaply, with no toxicity, and with no waste.

This invention is by no means limited just for children's use. Any person can pick up this implement and use it as a writing tool. It will be obvious how to write monochromatically. What is new, different, and nonobvious is that this implement actually mimics three traditional Chinese styles of art. Instead of spending three to five years mastering each style, with the techniques taught in an accompanying book and DVD the consumer can begin to create like the masters.

First, this implement can, mimic traditional Chinese brush techniques when used in a nonobvious manner. Like traditional Chinese brush painting, this implement can create dark or pale contrasts on line or plane, imparting the deep or shallow hues characteristic of traditional Chinese style.

Second, this implement can also be used in a nonobvious manner to create rainbow calligraphy. Since Chinese characters must be learned by rote memory through endless copying over and over, this implement makes it fun for children and adult learners to acquire the written language of China. Moreover, rainbow colors enhance the artistic expression of plain calligraphy. Within five minutes the consumer can be taught to use the implement in a manner that produces rainbow writing. Once the consumer becomes accustomed to the various nonobvious techniques, the flow and blend of colors and hues can be controlled at will.

Third, this implement can mimic the Dragon-Phoenix style, which is commonly referred to as “name writing” among street artists in New York City. Through nonobvious techniques that will be taught in an accompanying book and DVD, the consumer will learn the swirls and flourishes used to create names out of plum blossoms, dragons, birds, butterflies, bamboo, and other Chinese motifs.

### BRIEF DESCRIPTION OF THE DRAWINGS

FIG. 1 depicts the lateral views of the preferred embodiment. Subfigure one shows the side of the top portion along with the bottom portion of the red and yellow colors. Right under each portion is a cross section showing the vertical separation of the black and white of the top portion, and the blue, red and yellow of the bottom portion. Subfigure 2 shows the top portion only with cross section and Subfigure 3 shows the bottom portion only with cross section.

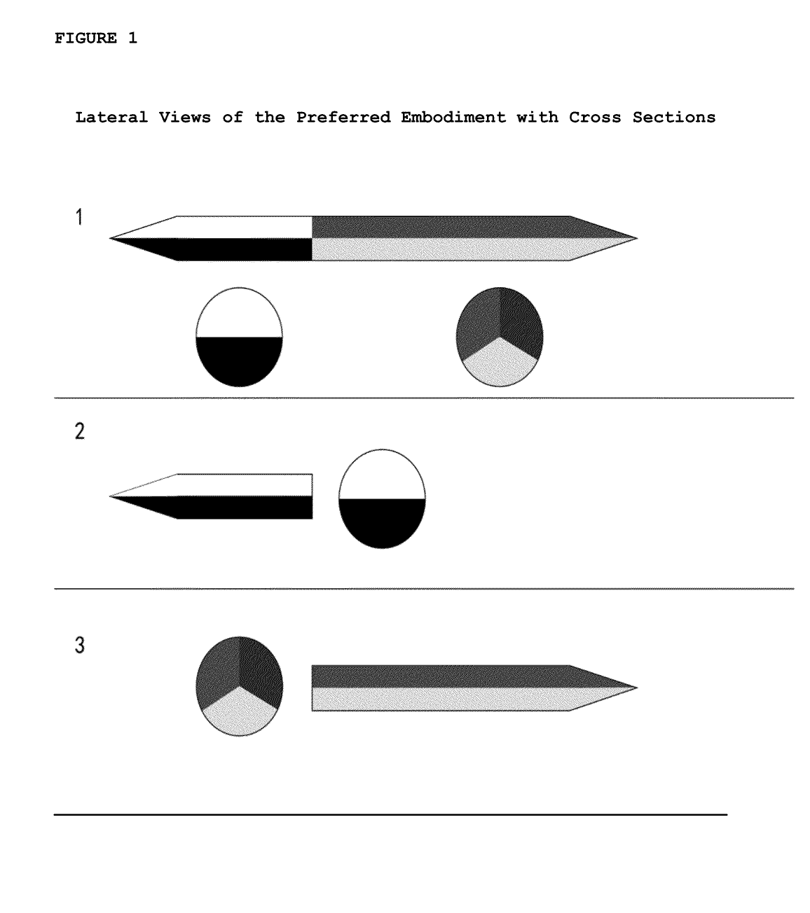

FIG. 2 depicts the inverted lateral view showing the bottom colors of yellow and blue, with cross sections.

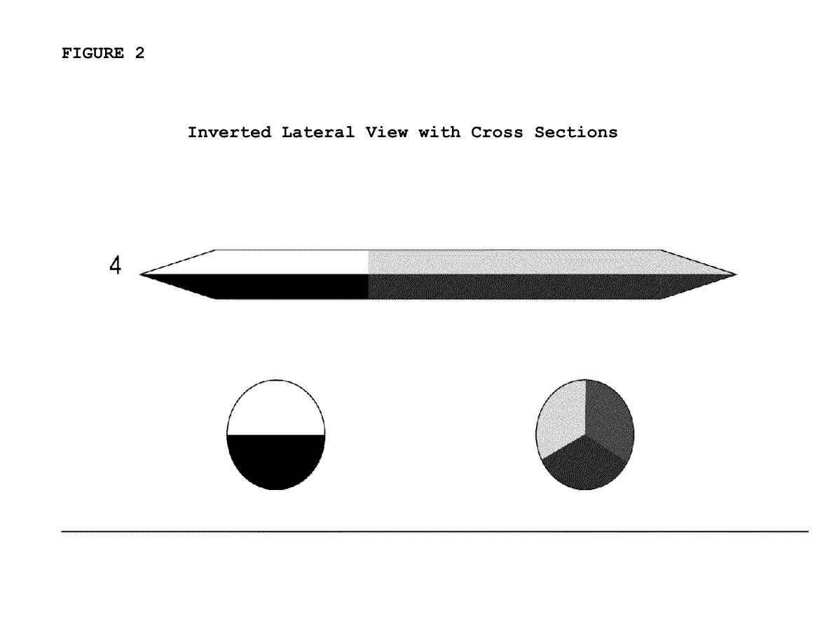

FIG. 3 depicts the vertical view of the black and white top portion with cross section.

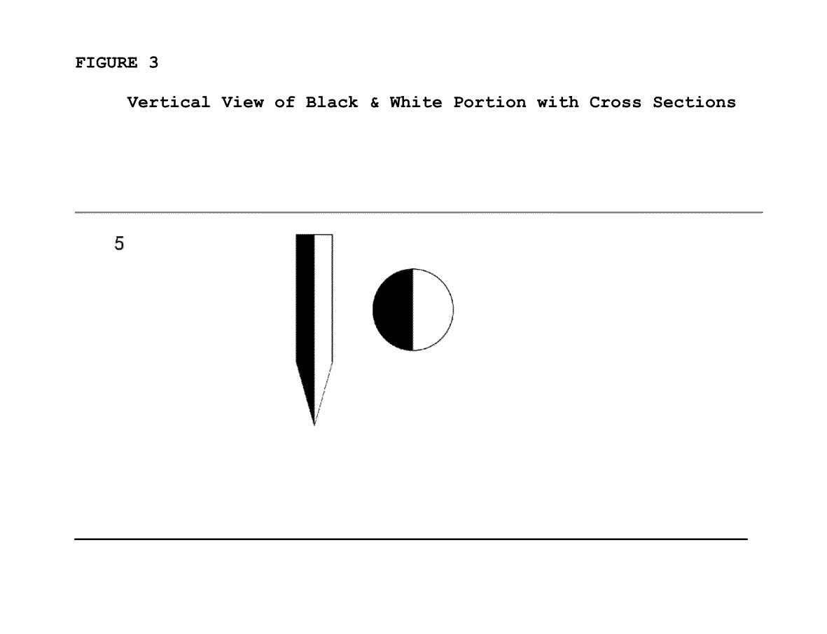

FIG. 4 depicts the vertical views of the bottom portion. Subfigure 6 shows the red and yellow side with cross section and Subfigure 7 shows the yellow and blue side with cross section.

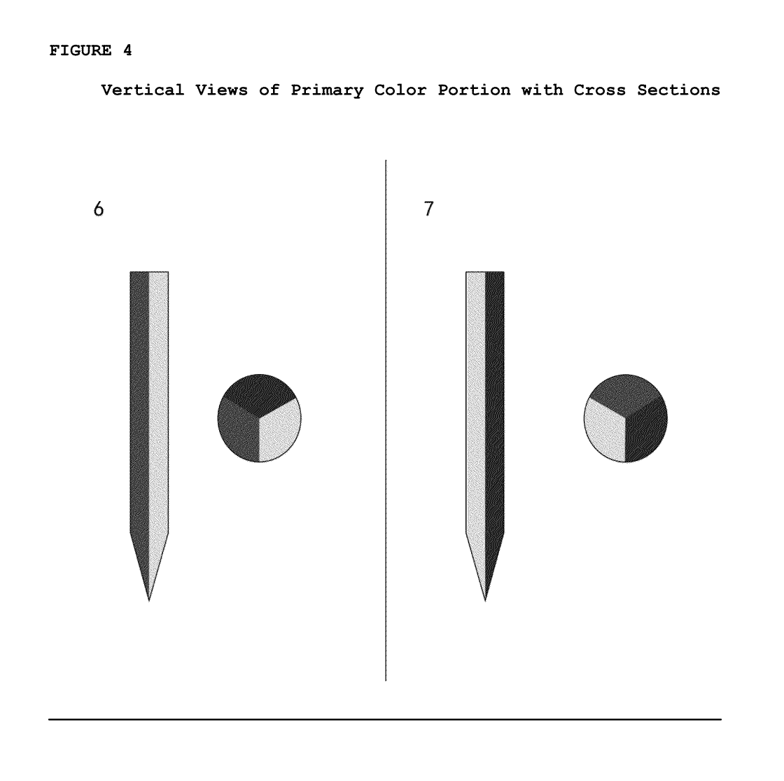

FIG. 5 depicts cross sections of three variations. Subfigure 8 shows that any two colors can be used in the top portion. Subfigure 9 shows that any three colors can be used in the bottom portion. Subfigure ten shows that even four colors can be produced.

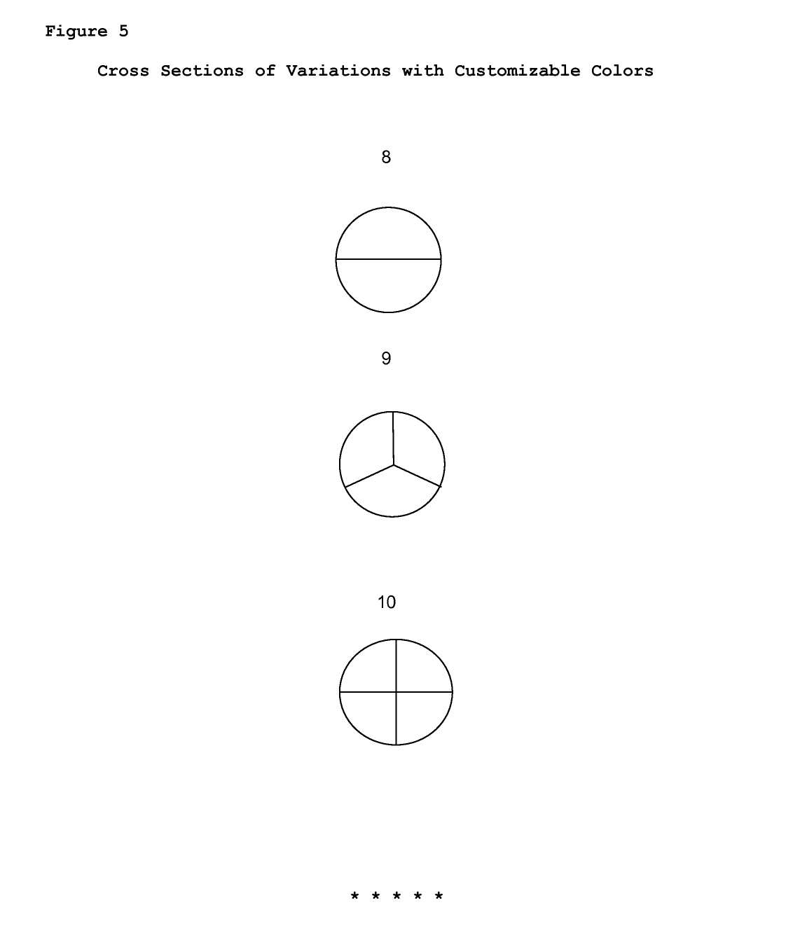

### DESCRIPTION OF THE PREFERRED EMBODIMENTS

This implement consists of a top portion divided into two vertical colors, black and white, which are comprised of a pastel-like toner compressed together in a cylinder shape and covered with a thin layer of wax. This top portion is fused with a bottom portion divided into three vertical colors, red, yellow, and blue, also comprised of the pastel-like toner compressed together in a cylinder shape and covered with a thin layer of wax. The wax can be removed from the desired colors to be used by a regular pencil sharpener or by gently rubbing on a piece of sandpaper.

It should be noted that the colors for the preferred embodiment are not merely aesthetic but are a necessary component. The three primary colors plus black and white are the minimum colors needed to create the entire color spectrum. Once the student becomes proficient in color blending and has developed an affinity for specific colors and hues, the implement can be custom designed to accommodate the colors of choice. A top portion of two, three, or four colors can be fused onto a bottom portion of two, three or four colors. While it is possible to exceed four colors, this drives up production costs so that it is no longer feasible. However, the preferred embodiment is cheap and easy to mass produce so that a color wheel artistic implement can be placed in the hand of every child.

What is claimed as being new and desired to be protected by Letters Patent of the United States is as follows:

1. An artistic implement comprising a lower body made of three compressed toner powders, and the upper body made of two compressed toner powders, and the entire cylinder coated with a thin layer of wax to prevent color bleeding.

2. The artistic implement of claim 1, wherein the upper and lower bodies are cylindrical in shape.

3. The artistic implement of claim 1, wherein the body is made by compressing said toner powders into a cylindrical shape and lightly coated with wax which prevents color bleeding.

4. The artistic implement of claim 1, wherein the colors on said body are separated vertically.

5. The artistic implement of claim 1, wherein the body is comprised of fusing the vertically separated, three compressed toner powders of the lower portion to the vertically separated, two compressed toner powders of the upper portion to create one cylindrical piece which is then lightly coated with wax.

6. The artistic implement of claim 1, wherein the colors used for the lower portion are the primary colors from the color wheel: red, yellow, and blue.

7. The artistic implement of claim 1, wherein the colors used for the upper portion are black and white.

8. The artistic implement of claim 1, wherein the colors used for the lower portion vary from those as described in claim 6, and are comprised of the secondary colors from the color wheel: orange, green, and violet, and where the upper portion is comprised as described in claim 7.

9. The artistic implement of claim 1, wherein the colors used for the lower portion vary from those as described in claims 6 and 8, and are comprised of the three or four colors of the consumer's choice for custom blending.

10. The artistic implement of claim 1, wherein the colors used for the upper portion vary from those as described in claims 7 and 8, and are comprised of the two, three, or four colors of the consumer's choice for custom blending.
